(19) United States
(12) Patent Application Publication
(10) Pub. No.: US 2005/0044076 A1
(43) Pub. Date: Feb. 24, 2005

(54) Information retrieval from multiple sources

(76) Inventors: Yuh-Cherng Wu, San Jose, CA (US); Kenneth Osborn, Oakland, CA (US); Barbara Bitterle, Campbell, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/781,143

(22) Filed: Feb. 18, 2004

Related U.S. Application Data
(60) Provisional application No. 60/496,181, filed on Aug. 18, 2003.

(51) Int. Cl. G06F 17/30

(52) U.S. Cl. 707/4

(57) ABSTRACT

One embodiment of the invention provides a computer-implemented method for obtaining information contained in multiple knowledge bases. In this embodiment, the method includes receiving a request for information from an application system, using the request to create a first search query, and using the first search query to obtain a first search result that includes information contained in a first knowledge base. The method further includes using the first search result to automatically create a second search query, and using the second search query to obtain a second search result that includes information contained in a second knowledge base.

### RELATED APPLICATION

The present application claims the benefit of the filing date of U.S. Provisional Application No. 60/496,181, which was filed on Aug. 18, 2003.

### TECHNICAL FIELD

This invention relates to information retrieval in computing systems.

### BACKGROUND

In today's technology age, information and information sources are plentiful. On the World Wide Web, for example, individuals are capable of obtaining information from all over the world. Database and web servers may provide users with information about fixing a car, buying products or services, and the like. By using search engines, an individual can quickly and easily search for information by entering a series of search terms.

Search engines often provide compilation and retrieval services. One example of a compilation service involves the use of “spiders” that crawl through the World Wide Web and search for web sites and web-site content. The information from these web sites is then compiled into search indexes. A master index may be used to store references to the various web sites and also to store information contained in the web-site content. Certain terms may be associated with the entries stored in the master index. Then, when an individual user enters one or more search terms during a search operation, the search engine references its master index to locate web-site references or web-site content associated with terms that match those from the user's search request.

Because of the growing amount of data contained within the World Wide Web and other information sources, it often may be difficult for users to obtain all of the information they need by using only a single search request. For example, if a user wants to obtain information from within a company's Intranet, the user may need to execute multiple searches and access multiple knowledge bases, or information sources, to retrieve all of the needed information. Alternatively, a service field agent may need to execute multiple searches and collect information from various different sources when interacting with customers.

### SUMMARY

Various embodiments of the present invention are provided herein. One embodiment provides a computer-implemented method for obtaining information contained in multiple knowledge bases. In this embodiment, the method includes receiving a request for information from an application system, using the request to create a first search query, and using the first search query to obtain a first search result that includes information contained in a first knowledge base. The method further includes using the first search result to automatically create a second search query, and using the second search query to obtain a second search result that includes information contained in a second knowledge base.

Various embodiments of the invention may have certain benefits and advantages. For example, in one embodiment, a work package service is capable of initiating a series of sequential search queries, wherein a given query may be based upon the results obtained from a previous query. In addition, the work package service is capable of collecting a set of search results containing information from multiple knowledge bases and providing these results to a front-end software application.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a computing system that may be used for obtaining information contained in multiple knowledge bases, according to one embodiment.

FIG. 2 is a use-case diagram of a method for retrieving information in the computing system shown in FIG. 1, according to one embodiment.

FIG. 3 is a block diagram of the services shown in FIG. 1, according to one embodiment.

FIG. 4 is a block diagram of various exemplary knowledge bases that may be contained within the knowledge repository shown in FIG. 1.

FIG. 5 is a block diagram of various exemplary software applications that may be contained within the computing system shown FIG. 1.

### DETAILED DESCRIPTION

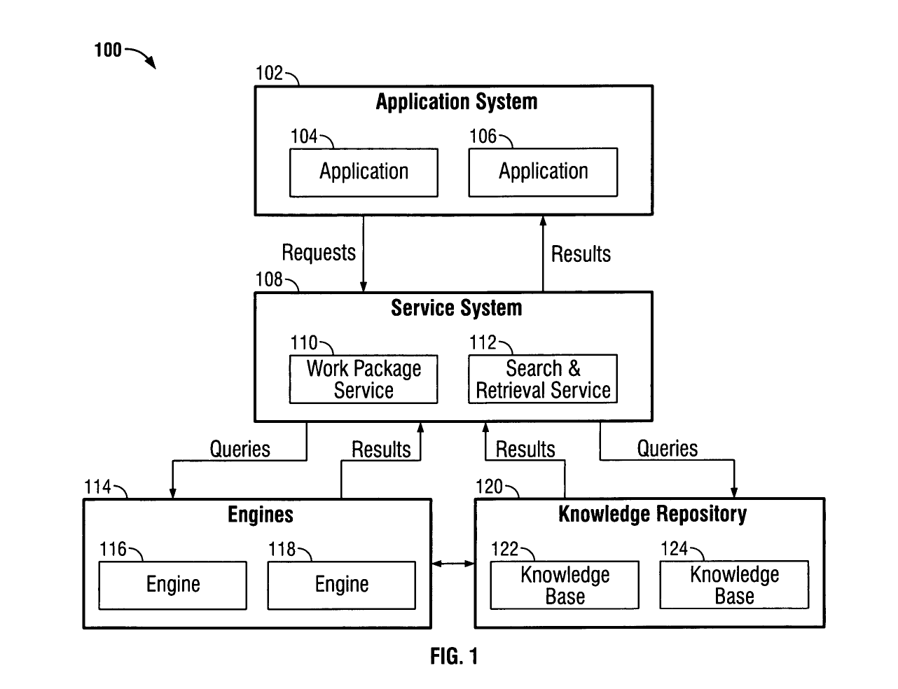

FIG. 1 is a block diagram of an exemplary computing system 100 that may be used to obtain information contained in multiple knowledge bases 122 and 124 upon receiving a request for information from a front-end software application 104 or 106. The knowledge bases 122 and 124 are contained within a knowledge repository 120, and the front-end software applications 104 and 106 are included within an application system 102. It is presumed that information has previously been stored in the knowledge bases 122 and 124. A service system 108 uses the request received from the front-end software application 104 or 106 to create a first search query, and the service system 108 then uses the first search query to obtain a first search result that includes information contained in a first knowledge base, such as the knowledge base 122. Subsequently, the service system 108 uses the first search result to automatically create a second search query, which is then used to obtain a second search result that includes information contained in a second knowledge base, such as the knowledge base 124. The service system 108 is then capable of sending the first and second search results back to the front-end software application 104 or 106.

The system 100 includes the application system 102, the service system 108, the knowledge repository 120, and a set of search engines 114. The application system 102 includes the software application 104 and the software application 106. In one embodiment, the software application 104 and the software application 106 are business applications, such as call-center applications. The application system 102 sends requests for information to the service system 108. Typically, these requests will include queries for information that is contained in the knowledge repository 120.

The service system 108 processes these requests once they are received from the application system 102. As shown in the example in FIG. 1, the service system 108 includes a work package service 110 and a search and retrieval service 112. In other embodiments, many other types of services may be included within the service system 108. The work package service 110 uses an individual request to create a search query, and then provides this query to the search and retrieval service 112. The search and retrieval service 112 then uses the query to obtain a search result that includes information contained in a first knowledge base, such as the knowledge base 122. In one embodiment, the search and retrieval service 112 sends the query to a particular search engine, such as the search engine 116, in the set of search engines 114. In this embodiment, the search engine 116 is associated with the knowledge base 122. The search engine 116 processes the query and then sends a result back to the search and retrieval service 112. In one embodiment, the search and retrieval service 112 sends the query directly to the knowledge base 122 in the knowledge repository 120. In this embodiment, the knowledge base 122 processes the query and then sends a result back to the search and retrieval service 112.

Once the search and retrieval service 112 receives the search result, it provides this result to the work package service 110. The work package service 110 then uses this result to automatically create a second search query. In one embodiment, the work package service 110 uses a set of predefined search rules when analyzing the result and creating the second search query, and does not require any additional input from the application system 102 to create this second search query. For example, if the result contains information about a product, the work package service 110 could extract the product identifier from this information and place this identifier into the second search query. The work package service 110 provides this second search query to the search and retrieval service 112, which then uses the second search query to obtain a second search result that includes information contained in a second knowledge base, such as the knowledge base 124.

Once the search and retrieval service 112 receives the second search result, it provides this result to the work package service 110. The work package service 110 then sends both search results back to the front-end software application 104 or 106 that sent the original request.

As stated earlier, the set of search engines 114 includes the search engine 116 and the search engine 118. Each search engine 116 and 118 is associated with, and assigned to, one of the knowledge bases 122 and 124 in the knowledge repository. For example, the search engine 116 may be associated with the knowledge base 122, while the search engine 118 may be associated with the knowledge base 124. In this example, the search engine 116 maintains an index of the information contained within the knowledge base 122, and the search engine 118 maintains an index of the information contained within the knowledge base 124. Each knowledge base 122 and 124 within the knowledge repository 120 contains a particular type of information that is compiled into the indexes maintained by the search engines 116 and 118.

In one embodiment, the service system 108 processes the search results obtained from the search engines 114 and/or the knowledge repository 120 before sending these results back to the front-end software application 104 or 106. For example, the search and retrieval service 112 may filter the search results according to a set of predefined filtering rules, or may classify the search results into categories according to a set of predefined classification rules. The search and retrieval service 112 may also use the search results to obtain additional information directly from the knowledge bases 122 and/or 124 as part of a follow-up retrieval process, such that both the search results and this additional information may be sent back to the front-end software application 104 or 106.

In one embodiment, the application system 102 and the service system 108 function on a single computing device. This device may include a processor, a storage device, a memory, and input/output devices. In another embodiment, the application system 102 and the service system 108 function on multiple computing devices.

In one embodiment, the functionality of the service system 108 is embodied in hardware. In another embodiment, the functionality of the service system 108 is embodied in software. In this embodiment, the software may be stored on a computer-readable medium, such as CD-ROM, floppy disk, hard disk, or other storage mechanism. In yet another embodiment, the functionality of the service system 108 is embodied in a combination of hardware and software.

The computing system 100 shown in FIG. 1 provides certain advantages. For example, the service system 108 is capable of initiating a series of sequential search queries, wherein a given query may be based upon the results obtained from a previous query. In addition, the work package service 110 is capable of collecting a set of search results containing information from multiple knowledge bases 122 and 124 and providing these results to a front-end software application 104 or 106.

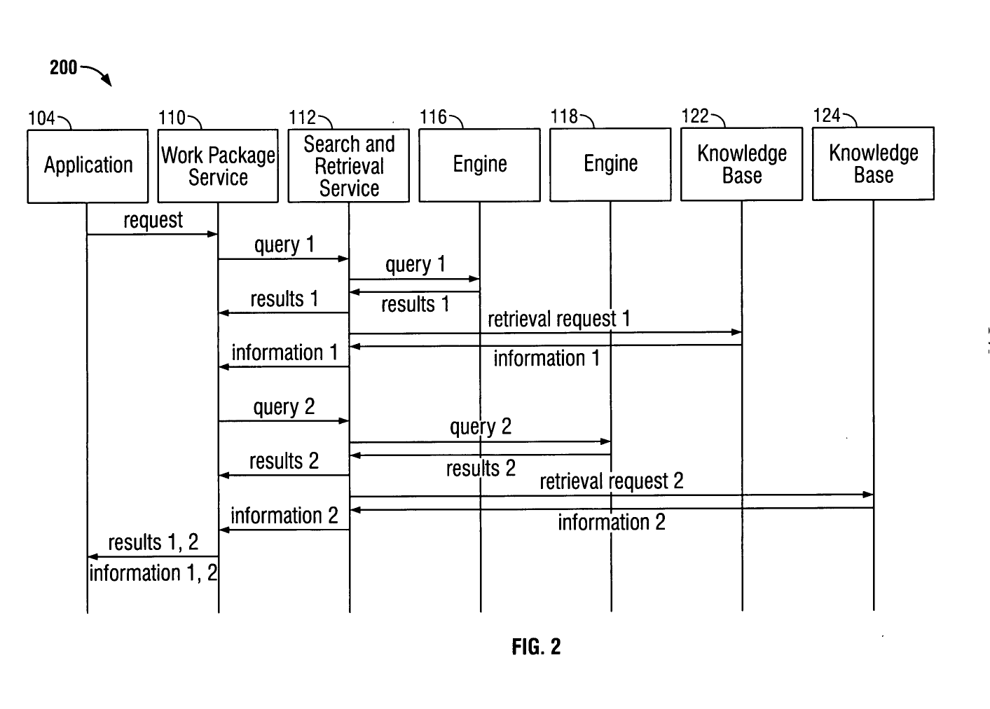

FIG. 2 is a use-case diagram 200 of a method for retrieving information in the computing system 100 shown in FIG. 1, according to one embodiment. The use-case diagram 200 includes the following actors: the application 104, the work package service 110, the search and retrieval service 112, the engine 116, the engine 118, the knowledge base 122, and the knowledge base 124. The method shown by the use-case diagram 200 allows the work package service 110 to collect information contained in multiple knowledge bases 122 and 124 and provide this information to the application 104.

The use-case diagram 200 starts by the application 104 sending a request for information to the work package service 110. This request may include a set of search terms and/or a set of search attributes. These search terms and/or search attributes provide a scope of the search that is requested by the application 104. In one embodiment, the request also specifies a particular knowledge base, such as the knowledge base 122 or 124, that is to be searched. The nature of the request will depend of the scenario. For example, if the application 104 is a call-center application, it may provide a request for service order information, and the request may specify that a service order knowledge base is to be included in the search.

The work package service 110 receives and examines the request sent from the application 104. In one embodiment, the work package service 110 will use a set of predefined rules to determine a search strategy. In this embodiment, the search strategy defines the ordering of sequential search operations that are to be performed. For example, although the application 104 may send a request for information that is contained in only a given knowledge base, the work package service 110 may determine that it will attempt to obtain information contained in one or more additional knowledge bases. The work package service 110 processes the incoming request sent from the application 104 and builds a first search query. The work package service 110 then sends this query to the search and retrieval service 112. As shown in FIG. 2, the search and retrieval service 112 then sends the query to the search engine 116. In one embodiment, the search and retrieval service 112 modifies the query before sending it to the search engine 116, so that the query conforms to the format expected by the search engine 116.

The search engine 116 is associated with the knowledge base 122. Therefore, the index maintained by the search engine 116 is compiled from information contained within the knowledge base 122. The search engine 116 will process the first query sent from the search and retrieval service 112 and access its search index to search for results that are associated with the contents of the query. For example, if the query specifies certain search terms and/or attributes, the engine 116 will search its index for results that includes these terms and/or attributes. After searching its index, the search engine 116 sends these results back to the search and retrieval service 112.

At this point, the search and retrieval service 112 sends these results back to the work package service 110. In many instances, these results will contain sufficient information in response to the first query sent by the work package service 110. In other instances, however, additional information may be needed. For example, if the results only contain an abstract of a technical article, the search and retrieval service 112 may determine that an additional search is required to obtain the full article. In these types of instances, the search and retrieval service 112 will send a retrieval request directly to the knowledge base associated with the given search engine. As shown in the use-case diagram 200, the search and retrieval service 112 sends a retrieval request for information to the knowledge base 122. This retrieval request is created by the search and retrieval service 112 using a set of rules to process the results that were obtained from the search engine 116. In response to receiving the retrieval request, the knowledge base 122 sends information back to the search and retrieval service 112, which then sends this information back to the work package service 110.

The work package service 110 will analyze the search results and information that it has received from the search and retrieval service. In one embodiment, the work package service 110 uses a set of predefined rules contained in work package scripts to analyze the search results and information. The work package service 110 uses these search results and information contained within the knowledge base 122 to build a second search query. For example, the work package service 110 may build a second, more refined search query that utilizes the information received from the knowledge base 122. If, for example, the search results contain product information, the work package service 110 may extract one or more particular product identifiers and include these within the second search query, which could then be used to search for frequently asked questions about these particular products. The work package service 110 then sends this second search query to the search and retrieval service 112.

After receiving the second search query, the search and retrieval service 112 routes this query to the search engine 118. In one embodiment, the search and retrieval service 112 will modify the query according to the format that is expected by the search engine 118. The search engine 118 is associated with the knowledge base 124. As such, the search engine 118 compiles its index from information that is contained in the knowledge base 124. The search engine 118 will analyze the second search query and search its index for corresponding results. The search engine 118 then sends these results back to the search and retrieval service 112.

The search and retrieval service 112 processes the results obtained from the search engine 118 and then routes these results back to the work package service 110. In the use-case diagram 200 shown in FIG. 2, the search and retrieval service 112 also creates a second retrieval request to obtain additional information from the knowledge base 124. The search and retrieval service 112 decides to create this second retrieval request after analyzing the results obtained from the search engine 118, and then sends this retrieval request to the knowledge base 124. The knowledge base 124 processes this retrieval request, and sends corresponding information back to the search and retrieval service 112. The search and retrieval service 112 then sends this information to the work package service 110.

At this point, the work package service 110 will have received the search results and information in response to the first search query, and also will have received the search results and information in response to the second search query. The work package service 110 sends all of these search results and corresponding information back to the application 104. In one embodiment, the work package service 110 bundles all of these results and corresponding information into a “work package” that is provided to the application 104. In one embodiment, the work package service 110 modifies the search results and information into a format that is usable by the application 104. For example, the work package service 110 may format the results and information into a Hypertext Markup Language (HTML) or a Portable Document Format (PDF) representation.

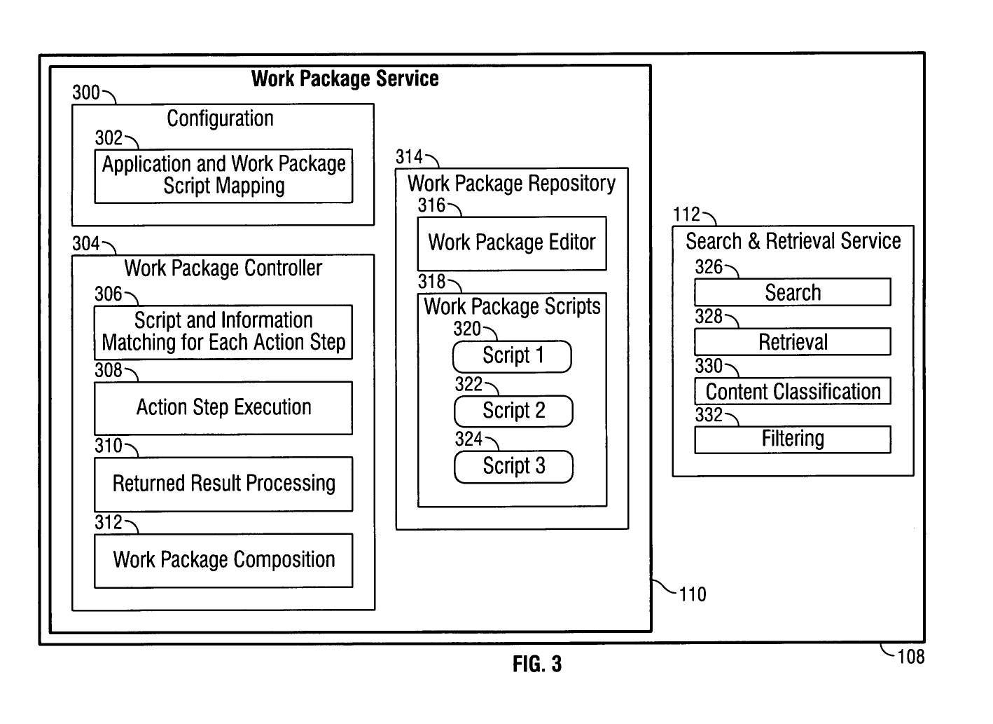

FIG. 3 is a block diagram of the service system 108 shown in FIG. 1, according to one embodiment. In this embodiment, the details of the work package service 110 and the search and retrieval service 112 are shown as in FIG. 3. Each of these services 110 and 112 are operable to receive requests for information from the application system 102 shown in FIG. 1, and to provide such information back to the application system 102. The services 110 and 112 are capable of obtaining information that is contained in the knowledge bases 122 and 124 within the knowledge repository 120.

As shown in FIG. 3, the work package service 110 contains a configuration module 300, a work package controller 304, and a work package repository 314. The configuration module 300 includes a mapping function 302. The mapping function 302 maps the applications 104 and 106 with work package scripts 318 within the work package repository. As shown in FIG. 3, the work package scripts 318 include a first script 320, a second script 322, and a third script 324. In one embodiment, each of the software applications 104 and 106 is associated with a particular work package script. The mapping function 302 provides the mappings between these applications 104 and 106 and the associated work package scripts. For example, the application 104 may be mapped to, and associated with, the first script 320 contained within the set of work package scripts 318. The application 106 may be mapped to, and associated with, the second script 322.

The work package repository 314 includes all of the work package scripts 318 and also a work package editor 316. A user, such as an administrator, may use the work package editor 316 to edit the work package scripts 318. Each work package script 320, 322, and 324 contains a set of predefined rules that may be used by the work package service 110 when processing requests from the application 104 and when processing information that is obtained from the engines 114 and/or the knowledge repository 120. In one embodiment, the scripts 318 contain a set of conditions and actions using if-then-else statements. When certain conditions are satisfied, corresponding actions are taken, as defined by the scripts 318. For example, the first script 320 could specify that, if a result is obtained that includes a product name, then a new search query is to be created that includes a request for a list of complaints that customer's have submitted about that particular product.

The work package controller 304 includes various functional components 306, 308, 310, and 312. The function 306 uses the appropriate script 320, 322, or 324 as determined by the mapping function 302 to process incoming information from the engines 114 or the knowledge repository 120. The function 306 processes this information for each action step of the given script. That is, the function 306 tests the conditions of the script 320, 322, or 324 and determines which actions are to be taken. The function 308 executes each appropriate action step in the given script. The function 310 processes the information and results that are returned from the engines 114 and/or the knowledge repository 120 in preparation of sending the information and results back to the application 104. The function 312 composes a “work package” that includes the information and results in one organized unit that can be sent to and processed by the application 104.

The search and retrieval service 112 includes a search function 326, a retrieval function 328, a content classification function 330, and a filtering function 332. The search function 326 uses the search queries received from the work package service 110 to search for information provided by the search engines 114. The retrieval function 328 sends retrieval requests to the knowledge bases 122 and 124 within the knowledge repository 120. In one embodiment, the retrieval function 328 uses the results obtained by the search function 326 to create the retrieval requests. The search and retrieval service 112 is capable of sending the information obtained by the search and retrieval functions 326 and 328 back to the work package service 110.

The content classification function 330 classifies and categorizes the information obtained by the search and retrieval functions 326 and 328 according to a set of predefined classification rules. The content classification function 330 uses these rules to categorize the information in an organized fashion before it is sent back to the work package service 110. The filtering function 332 filters the information obtained by the search and retrieval functions 326 and 328 according to a set of predefined filtering rules. The filtering function 332 uses these rules to decrease the amount of information that is passed back to the work package service 110. For example, a given filtering rule may filter out all ranking information that is obtained and that falls below a predefined threshold value.

The work package service 110 and the search and retrieval service 112 serve as functional interfaces between the application system 102 and both the engines 114 and knowledge repository 120 shown in FIG. 1. The work package service 110 receives information requests from the application system 102 and uses work package scripts to identify a series of search operations that are to be performed. The search and retrieval service 112 obtains search results from the engines 114 and also information from the knowledge repository 120, and provides these results and information to the work package service 110. The work package service 110 then bundles all of the results and information that has been collected by the search and retrieval service 112 and sends these results and information back to the application system 102 in response to their requests.

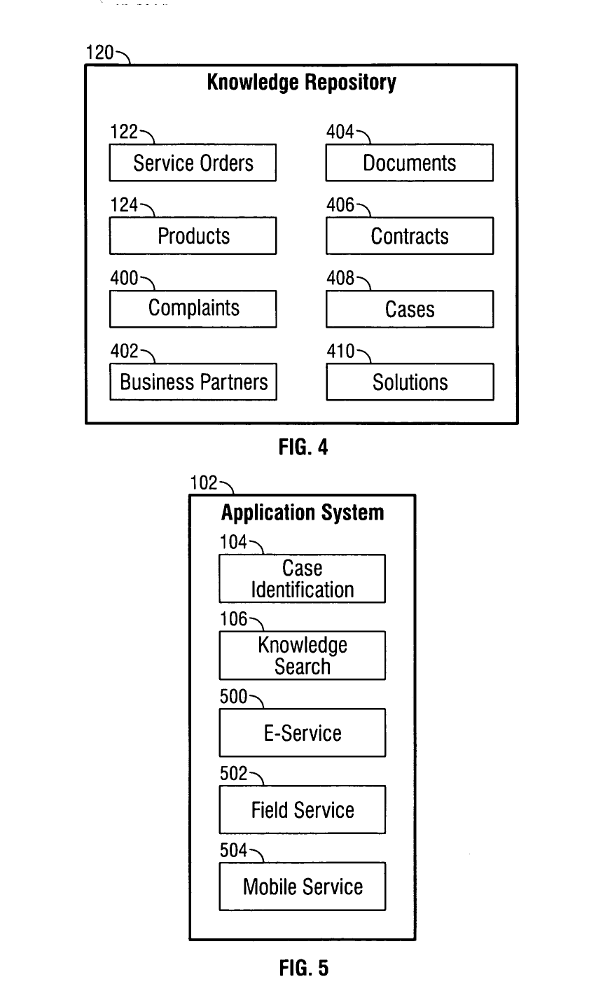

FIG. 4 is a block diagram of various exemplary knowledge bases that may be contained within the knowledge repository 120 shown in FIG. 1. As described in FIG. 1, the knowledge repository 120 may include a variety of different knowledge bases, each containing a particular kind of information. The exemplary knowledge repository 120 shown in FIG. 4 includes the knowledge bases 122, 124, 400, 402, 404, 406, 408, and 410. The service system 108 shown in FIG. 1 may obtain information from any number of these knowledge bases when processing requests sent from the application 104. Because FIG. 1 focuses on the information retrieval process, it is assumed that information has previously been stored in each of these knowledge bases.

The knowledge base 122 contains information about service orders that have been processed while interacting with customers. The knowledge base 124 contains information about products that may be sold, repaired, etc. The knowledge base 400 contains information about complaints that have been made and logged by customers. The knowledge base 402 contains information about the business partners (i.e., customers) that have been identified from prior interactions. The knowledge base 404 contains information about various miscellaneous documents. The knowledge base 406 contains information about contracts that have been created between service/product providers and customers. The knowledge base 408 contains information about specialized business cases for certain business transactions. An individual case may contain various forms of information about an entire transaction, or session, with a particular customer or client. Finally, the knowledge base 410 contains information about solutions to problems that have been previously identified.

FIG. 5 is a block diagram of various exemplary software applications that may be contained within the application system 102 shown FIG. 1. As described in FIG. 1, the application system 102 may include a variety of different applications, such as business applications. The software applications shown in FIG. 5 include a case identification application 104, a knowledge search application 106, an e-service application 500, a field service application 502, and a mobile service application 504. Each of these applications may send requests for information to the service system 108 shown in FIG. 1.

The case identification application 104 is operable to identify various cases in a service environment using session or entity information. The knowledge search application 106 is operable to search for knowledge in various forms. The e-service application 500 is operable to provide electronic service functionality to customers. The field service application 502 is operable to provide support to field-service agents while they interact with customers. The mobile service 504 is operable to provide support to users or agents who use mobile devices. Each of these applications may obtain information contained in one or more of the knowledge bases in the knowledge repository 120. In certain instances, the application system 102 may initially provide a request to obtain information contained in only a particular knowledge base, while the service system 108 may then determine to submit queries to obtain information that is contained in one or more additional knowledge bases.

A number of embodiments of the invention have been described. Nevertheless, it will be understood that various modifications may be made without departing from the spirit and scope of the invention. Accordingly, other embodiments are within the scope of the following claims.

1. A computer-implemented method for obtaining information contained in multiple knowledge bases, the method comprising:
receiving a request for information from an application system;
using the request to create a first search query;
using the first search query to obtain a first search result that includes information contained in a first knowledge base;
using the first search result to automatically create a second search query; and
using the second search query to obtain a second search result that includes information contained in a second knowledge base.

2. The computer-implemented method of claim 1, wherein the method further comprises sending the first and second search results back to the application system.

3. The computer-implemented method of claim 2, wherein the method further comprises processing the first and second search results.

4. The computer-implemented method of claim 3, wherein processing the first and second search results includes:
using the first search result to obtain additional information from the first knowledge base; and
sending the additional information obtained from the first knowledge base back to the application system.

5. The computer-implemented method of claim 3, wherein processing the first and second search results includes filtering the first and second search results according to a set of predefined filtering rules.

6. The computer-implemented method of claim 3, wherein processing the first and second search results includes classifying the first and second search results according to a set of predefined classification rules.

7. The computer-implemented method of claim 1, wherein using the first search result to automatically create a second search query includes using the first search result along with a set of predefined search rules to automatically create the second search query.

8. The computer-implemented method of claim 1, wherein using the first search result to automatically create a second search query includes:
extracting information from the first search result; and
including the extracted information within the second search query.

9. The computer-implemented method of claim 1, wherein:
using the first search query to obtain a first search result includes obtaining the first search result directly from the first knowledge base; and
using the second search query to obtain a second search result includes obtaining the second search result directly from the second knowledge base.

10. The computer-implemented method of claim 1, wherein:
using the first search query to obtain a first search result includes obtaining the first search result from a first search engine; and
using the second search query to obtain a second search result includes obtaining the second search result from a second search engine.

11. The computer-implemented method of claim 1, wherein the application system includes a call-center application.

12. A computer system for obtaining information contained in multiple knowledge bases, the computer system being programmed to:
receive a request for information from an application system;
use the request to create a first search query;
use the first search query to obtain a first search result that includes information contained in a first knowledge base;
use the first search result to automatically create a second search query; and
use the second search query to obtain a second search result that includes information contained in a second knowledge base.

13. A computer-readable medium having computer-executable instructions contained therein for performing a method, the method comprising:
receiving a request for information from an application system;
using the request to create a first search query;
using the first search query to obtain a first search result that includes information contained in a first knowledge base;
using the first search result to automatically create a second search query; and
using the second search query to obtain a second search result that includes information contained in a second knowledge base.
